(19) United States
(12) Patent Application Publication
(10) Pub. No.: US 2024/0108194 A1
(43) Pub. Date: Apr. 4, 2024

(54) CONVEYOR WAREWASHER AND METHOD FOR OPERATING A CONVEYOR WAREWASHER

(71) Applicant: ILLINOIS TOOL WORKS INC., Glenview, IL (US)

(72) Inventors: Harald DISCH, Elzach (DE); Martin SCHREMPP, Biberach (DE)

(21) Appl. No.: 18/475,352

(22) Filed: Sep. 27, 2023

(30) Foreign Application Priority Data
Sep. 28, 2022 (DE) 10 2022 124 968.9

(51) Int. Cl. A47L 15/42; A47L 15/00; A47L 15/24; G06T 7/70; G06V 10/26; G06V 10/764

(52) U.S. Cl. CPC A47L 15/4295; A47L 15/0026; A47L 15/0028; A47L 15/0034; A47L 15/241; G06T 7/70; G06V 10/26; G06V 10/764; A47L 2401/04; A47L 2501/26; A47L 2501/30; A47L 2501/32; G06T 2207/20081

(57) ABSTRACT

A conveyor warewasher includes at least one washing zone, at least one rinsing zone and a conveyor apparatus. A camera system is configured in order to capture at least one image of an portion of the conveyor apparatus continuously or at predetermined or determinable times and/or events. An image processing device is associated with the camera system and is configured to determine a position, orientation and/or alignment of washware items present in the at least one captured image. An evaluation device is further provided that is adapted to determine based on the determined position, orientation, and/or alignment of the washware items whether, at the time of the image capture, washware items are present in the portion of the conveyor apparatus (2) that: i) are transported incorrectly oriented by the conveyor apparatus (2); and/or ii) are transported misaligned by the conveyor apparatus.

### TECHNICAL FIELD

The present invention relates generally to the field of industrial rinsing, and in particular to a conveyor warewasher for cleaning washware, wherein the conveyor warewasher comprises at least one washing zone and at least one rinsing zone, as well as a conveyor apparatus for conveying the washware through the at least one washing zone and the at least one rinsing zone. The conveyor warewashers according to the invention can, in particular, be designed as belt conveyor warewashers or as rack conveyor warewashers.

### BACKGROUND

Conveyor warewashers are used in the commercial sector. In contrast to domestic dishwashers, in which the washware to be cleaned remains stationary in the machine during cleaning, in conveyor warewashers the washware is conveyed through different treatment zones of the conveyor warewasher.

In the case of conveyor warewashers, the washware, for example dishes, pots, glasses, cutlery, and other utensils to be cleaned, are conveyed through a plurality of treatment zones, for example through at least one pre-washing zone, at least one main washing zone, at least one post-washing zone or pre-rinsing zone, at least one fresh water rinsing zone, and at least one drying zone. However, different types of washware require different treatment parameters for the individual process steps due to their application, their degree of soiling, their shape, and the material used. However, in today's conveyor warewashers, there is usually no automatic differentiation of the types of washware, so that the conventional systems are often designed as a compromise in order to be usable for several different types of washware.

In particular, conventional conveyor warewashers are designed to start with washware to be cleaned, which is received from the conveyor apparatus of the conveyor warewasher such that the individual washware items are optimally aligned with respect to the washing and rinsing systems of the treatment zones of the conveyor warewasher. In the design of conventional conveyor warewashers, it is particularly assumed in an unrealistic manner that the individual washware items received by the conveyor apparatus of the conveyor warewasher do not form spray shadows among one another that make treatment of the individual washware items in the treatment zones more difficult or not possible at all. Rather, in the design of conventional conveyor warewashers, it is generally assumed that the washware to be received and cleaned by the conveyor apparatus and to be cleaned is optimally oriented and aligned, so that the washing and rinsing systems of the treatment zones of the conveyor warewasher can then treat the washware items accordingly.

However, in practical use, such an optimally oriented and optimally aligned accommodation of the washware items to be cleaned on the conveyor apparatus is not viable, since the washing personnel assigned to the conveyor warewasher must often load the accumulating washware items into the conveyor warewasher under high time pressure, as a result of which it is usually not possible to ensure that the loaded washware items are always optimally oriented and aligned.

This leads to the rinsing and washing result of the conveyor warewasher being unsatisfactory under certain circumstances despite adjusted treatment parameters. For example, when a washware item such as a pitcher, or a container such as a pan, is placed on the conveyor apparatus of the conveyor warewasher in the wrong direction, it is not possible for the cleaning liquid (washing liquid and rinsing liquid) that is sprayed by the washing systems to optimally cover the most soiled areas of the washware item when treating this washware item in the treatment zones of the conveyor warewasher. An undertreatment of the washware items is thus pre-programmed.

### SUMMARY

Based on this problem, the object of the invention is to further develop a conveyor warewasher of the above-mentioned type such that, the washing and rinsing result of the conveyor warewasher is optimized in an effective manner while reducing the utilization of resources (water, energy, and chemicals). Furthermore, a corresponding method of operating such a conveyor warewasher is to be specified.

Accordingly, the present invention relates in particular to a conveyor warewasher for cleaning washware, wherein the conveyor warewasher comprises at least one washing zone and at least one rinsing zone, and a conveyor apparatus for transporting washware through the at least one washing zone and the at least one rinsing zone.

According to the invention, it is provided in particular that the conveyor warewasher comprises a camera system which is arranged above, below, or laterally to the conveyor apparatus, and is designed to record at least one image of an area of the conveyor apparatus, preferably continuously or at times and/or events which are defined or can be defined in advance.

In particular, the solution according to the invention provides that an image processing device is associated with the camera system, and is designed to determine a position, location, and/or orientation of the washware items contained in the at least one captured image. Furthermore, an evaluation device is used, which is designed to evaluate the determined position, location, and/or orientation of the washware items and determine whether there are washware items in the area of the conveyor apparatus at the time of the image acquisition which:
i) are transported in an incorrect orientation by the conveyor apparatus; and/or
ii) are transported in an incorrectly aligned orientation by the conveyor apparatus.

In this context, it is particularly conceivable and advantageous that the conveyor warewasher comprises a control device which is designed to issue an error or warning message, in particular to the washing personnel assigned to the conveyor warewasher and/or to the operator of the conveyor warewasher, if it is determined by the evaluation device that at the time of the image capture in the area of the conveyor apparatus:
at least one incorrectly oriented washware item is being transported by the conveyor apparatus; and/or
a pre-determined or fixed (minimum) number of incorrectly oriented washware items are being transported by the conveyor apparatus; and/or
at least one incorrectly aligned washware item is being transported by the conveyor apparatus; and/or
a pre-determined or fixed (minimum) number of incorrectly aligned washware items are being transported by the conveyor apparatus.

In this case, the control device is designed to have a regulating effect on the conveyor warewasher and in particular on the conveyor apparatus of the conveyor warewasher and, in particular, to stop the conveyor apparatus of the conveyor warewasher and/or reverse the transport direction of the conveyor apparatus at least temporarily (in order to optionally move the conveyor apparatus back a little if necessary (e.g., in the case of very large washware items)), if the evaluation device determines that at the time of the image capture in the area of the conveyor apparatus:
at least one incorrectly oriented washware item is being transported by the conveyor apparatus; and/or
a pre-determined or fixed (minimum) number of incorrectly oriented washware items are being transported by the conveyor apparatus; and/or
at least one incorrectly aligned washware item is being transported by the conveyor apparatus; and/or
a pre-determined or fixed (minimum) number of incorrectly aligned washware items are being transported by the conveyor apparatus.

It is conceivable, in particular in this context, that the control device is designed to activate or deactivate an additional washing system in the at least one washing zone and/or an additional rinsing system in the at least one rinsing zone of the conveyor warewasher and/or an additional drying system in an optional drying zone of the conveyor warewasher, and/or to vary a quantity of washing liquid sprayed per time unit in the at least one washing zone and/or a quantity of rinsing liquid sprayed per time unit in the at least one rinsing zone, and/or to vary a quantity of drying air sprayed per time unit in an optional drying zone, if it is determined by the evaluation device that at the time of the image acquisition in the area of the conveyor apparatus:
at least one incorrectly oriented washware item is being transported by the conveyor apparatus; and/or
a pre-determined or fixed (minimum) number of incorrectly oriented washware items are being transported by the conveyor apparatus; and/or
at least one incorrectly aligned washware item is being transported by the conveyor apparatus; and/or
a pre-determined or fixed (minimum) number of incorrectly aligned washware items are being transported by the conveyor apparatus.

When evaluating the at least one captured image, algorithms are in particular systematically applied to determine the correct or incorrect orientation and/or alignment of the washware items in order to synthesize an underlying relationship between the data and the information by using a machine learning method. The feature of particularly supervised machine learning is to find a function that generalizes from a training experience and outputs a hypothesis regarding similar data. The key difference between machine learning and simple interpolation consists of this step of generalization.

Therefore, according to implementations of the present invention, it is provided that the evaluation device is designed to determine on the basis of training data and, in particular, on the basis of training images whether, at the time of the image capture, there are washware items in the region of the conveyor apparatus which are being transported by the conveyor apparatus in the wrong orientation; and/or which are being transported by the conveyor apparatus in the wrong alignment.

In particular, it is conceivable in this context that the evaluation device is designed to determine, by comparing at least certain regions of the at least one recorded image with training images recorded in the course of a learning phase, whether, at the time of the image recording, there are washware items in the region of the conveyor apparatus which are being transported by the conveyor apparatus in the wrong orientation; and/or which are being transported by the conveyor apparatus in the wrong alignment.

In accordance with another aspect of the present invention, the conveyor warewasher is provided with a certain “intelligence”, in particular in order to artificially generate knowledge in the course of machine learning with regard to the alignment/orientation of the washware items based on experience. In other words, according to the further aspect of the invention, the conveyor warewasher according to the invention is designed to learn from examples, and the conveyor warewasher can generalize these learned examples upon completion of the learning period. To this end, a control device of the conveyor warewasher is designed to use algorithms to build a statistical model based on training data, which can furthermore be tested against test data.

In particular, according to implementations of the last-mentioned aspect of the present invention, it is provided that the conveyor warewasher comprises a control device which is designed, in particular during an observation phase over an observation period which preferably relates to a washing shift or washing day of the conveyor warewasher, to determine a temporal development of the incorrectly oriented and/or incorrectly aligned washware items to be washed as determined by the evaluation device, and preferably to derive a pattern or regularity on the basis of this determined temporal development.

Alternatively or in addition, the control device of the conveyor warewasher is designed, in particular during an observation phase over an observation period that preferably relates to a washing shift or washing day of the conveyor warewasher, to generate statistics on the type and/or time of the incorrectly oriented and/or incorrectly aligned washware items to be washed.

In this embodiment of the conveyor warewasher according to the invention, it is particularly preferable for the control device to be furthermore designed to generate a corresponding message as a function of the determined temporal development and/or as a function of the generated statistics; and/or to output it to, in particular, the operator of the conveyor warewasher, wherein the message preferably contains a recommendation for optimized operation of the conveyor warewasher, in particular with regard to cleaning efficiency.

In order to implement the conveyor warewasher according to the invention, it is provided in accordance with embodiments of the invention that the image processing device is designed, in particular optionally designed, to preprocess the at least one image recorded by the camera system, to segment the—in particular optionally preprocessed—image, and to perform feature extraction and classification of objects contained in the image.

Within this context, it is convenient that the image processing device is furthermore designed to determine a position, location, and/or orientation of the washware items in the area of the conveyor apparatus as an attribute of the washware items that are contained in the image. The image processing device is preferably furthermore adapted to classify the washware items based on the determined position, orientation, and/or alignment of the washware items in the area of the conveyor apparatus, namely as follows:
a) a first class comprising washware items whose orientation does not correspond to a predetermined or predeterminable orientation; and/or
b) a second class comprising washware items whose orientation corresponds to a predetermined or predeterminable orientation; and/or
c) a third class comprising washware items whose alignment does not correspond to a predetermined or predeterminable alignment; and/or
d) a fourth class comprising washware items whose alignment corresponds to a predetermined or predeterminable alignment.

According to further embodiments of this embodiment variant of the conveyor warewasher according to the invention, it is provided that the image processing device is furthermore designed to classify the washware items to be washed in the area of the conveyor apparatus on the basis of the determined position, location, and/or orientation of the washware items, as follows:
e) a fifth class comprising washware items whose orientation on the conveyor apparatus does not correspond to a pre-determined or predeterminable location; and/or
f) a sixth class comprising washware items whose alignment on the conveyor apparatus corresponds to a pre-determined or predeterminable location.

According to the implementations of the most recently mentioned aspects, it is, in particular, provided that the orientation of a washware item corresponds to the pre-determined orientation when the washware item is transported, in particular transported in an upside-down position, by the conveyor apparatus.

Alternatively or additionally, it is conceivable in this context that the alignment of a washware item corresponds to the predetermined orientation when the washware item is oriented upside down with respect to the conveyor apparatus.

Of course, other definitions of the optimum orientation and/or alignment of the washware items are also possible here. In fact, the optimum orientation and alignment of the respective washware items depends on their size and shape.

The task underlying the invention is furthermore solved by a method of operating a conveyor warewasher, in particular a conveyor warewasher of the aforementioned type according to the invention, or a conveyor warewasher according to the generic term of claim 1. In the method according to the invention, it is provided that, preferably at an inlet area of the conveyor warewasher and, in particular, within an inlet tunnel of the conveyor warewasher, at least one image of an area of a conveyor apparatus of the conveyor warewasher is taken from above, from below, or from the side. Subsequently, the at least one image is optionally preprocessed, and the optionally preprocessed image is segmented using an image processing device to extract features of objects contained in the image, and to classify the objects. Finally, the classification performed is used to determine, with the aid of an evaluation device, whether at least one incorrectly oriented washware item is being transported by the conveyor apparatus at the time at which the image is captured in the area of the conveyor apparatus, and/or whether at least one incorrectly aligned washware item is being transported by the conveyor apparatus at the time at which the image is captured in the area of the conveyor apparatus.

According to a further development of the method according to the invention, it is provided that an error or warning message is, in particular, issued to the washing personnel assigned to the conveyor warewasher and/or to the operator of the conveyor warewasher if the evaluation device determines that, at the time of the image acquisition in the area of the conveyor apparatus:
at least one incorrectly oriented washware item is being transported by the conveyor apparatus; and/or
a pre-determined or fixed (minimum) number of incorrectly oriented washware items are being transported by the conveyor apparatus; and/or
at least one incorrectly aligned washware item is being transported by the conveyor apparatus; and/or
a pre-determined or fixed (minimum) number of incorrectly aligned washware items are being transported by the conveyor apparatus.

According to further developments of the method according to the invention, this covers the aspect of machine learning. In particular, it is conceivable within this context that, in particular during an observation phase over an observation period which preferably relates to a rinsing shift or rinsing day of the conveyor warewasher, a temporal development of the incorrectly oriented and/or incorrectly aligned washware items that are detected by the evaluation device is determined, and a pattern or regularity is preferably derived on the basis of this determined temporal development.

Alternatively or in addition, it is conceivable that, in particular during an observation phase over an observation period which preferably relates to a rinsing shift or rinsing day of the conveyor warewasher, statistics are compiled regarding the type and/or time of the incorrectly oriented and/or incorrectly aligned washware items that are being transported by the conveyor apparatus.

In a further development of the most recently mentioned conceivable realization of the operating method according to the invention, it is provided that, as a function of the determined temporal development and/or as a function of the compiled statistics, a corresponding message is generated and/or issued to, in particular, the operator of the conveyor warewasher, wherein the message preferably contains a recommendation for optimized operation of the conveyor warewasher, in particular with regard to cleaning efficiency.

### BRIEF DESCRIPTION OF THE DRAWING

An exemplary embodiment of the conveyor warewasher according to the invention is described in the following with reference to the attached drawing.

The following are shown:

FIG. 1 a schematic longitudinal sectional view of a conveyor warewasher according to an exemplary embodiment of the invention.

### DETAILED DESCRIPTION

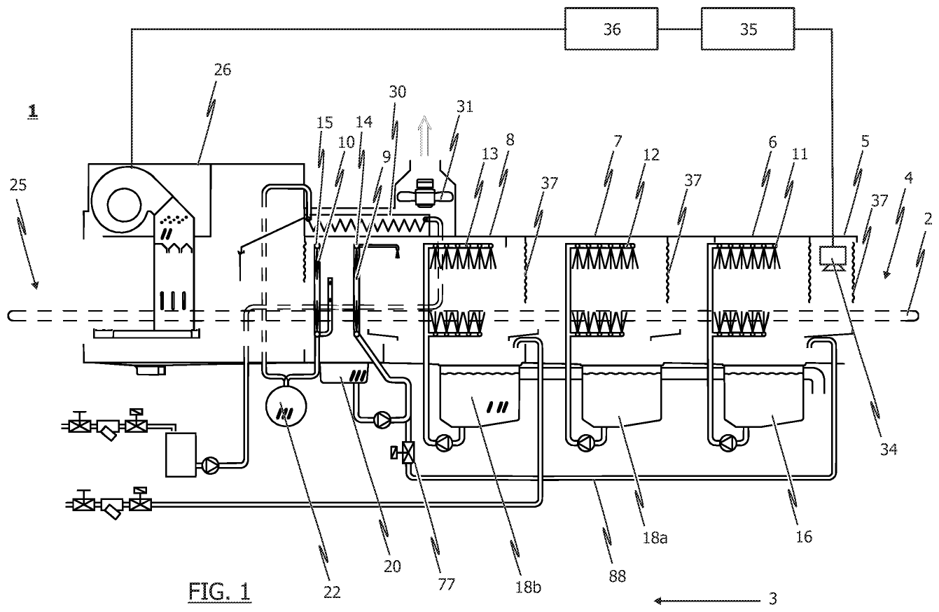

FIG. 1 shows a conveyor warewasher 1 with a conveyor apparatus 2 for conveying washware not shown in the drawings through the conveyor warewasher 1 in a direction of conveyance 3.

The conveyor apparatus 2 can be, for example, a conveyor belt, which is preferably designed as a multi-part plastic conveyor belt and is continuously driven by an electric drive not shown in FIG. 1, so that the washware placed upon the conveyor belt 2 is conveyed through the various treatment zones 6, 7, 8, 9, 10, and 26 of the conveyor warewasher 1 according to the illustration in FIG. 1.

Typically, the washware conveyed in the direction of conveyance 3 is placed upon the conveyor apparatus or conveyor belt 2 in the area of the inlet 4. According to the direction of conveyance 3 indicated by the arrow, the washware is then conveyed from the inlet 4 into an inlet tunnel 5.

The conveyor warewasher 1 according to the first embodiment of the present invention has at least one washing zone, for example as shown in FIG. 1, a pre-washing zone 6, as well as a first main washing zone 7 and a second main washing zone 8, which are arranged downstream of the pre-washing zone 6 when viewed in the direction of conveyance 3.

In the conveyor warewasher 1 shown in FIG. 1, a post-washing zone 9 and a rinsing zone 10 downstream of the post-washing zone 9 are arranged downstream of the at least one washing zone 6, 7, 8 when viewed in the direction of conveyance 3.

In the illustration according to FIG. 1, the conveyor apparatus 2 is shown as a circumferential conveyor belt. However, conveyor racks in which the not explicitly shown washware is inserted and which are placed on the top of the conveyor belt are also conceivable as the conveyor apparatus 2.

When viewed in the direction of conveyance 3, the washware received either directly on the conveyor belt 2 or held by racks runs in the direction of conveyance 3 through the inlet tunnel 5, the subsequent pre-washing zone 6, the first main washing zone 7, the second main washing zone 8, the post-washing zone 9, the rinsing zone 10, a drying zone 26, and into an outlet path 25.

Spray nozzles 11, 12, 13, 14, and 15 are respectively associated with the aforementioned treatment zones 6, 7, 8, 9, and 10 of the conveyor warewasher 1, via which nozzles liquid is sprayed onto the washware conveyed by the conveyor apparatus 2 through the respective treatment zones 6, 7, 8, 9, and 10. Each treatment zone 6, 7, 8, 9, and 10 is associated with a tank 16, 18, 20, and 22 in which sprayed liquid is received and/or in which liquid is provided for the spray nozzles of the respective zones. In the conveyor warewasher 1 shown in FIG. 1, rinsing liquid is sprayed onto the washware, not shown in the illustrations, in the form of fresh water, which may be pure or mixed with further additives such as rinsing agents, via the spray nozzles 15 of the rinsing zone 10 arranged above and below or to the side of the conveyor belt.

A portion of the sprayed rinsing liquid is conveyed from zone to zone in a cascading system counter to the direction of conveyance 3 of the washware. The remaining portion is guided directly into the pre-wash tank 16 via a valve 77 and a bypass line 88.

The sprayed rinsing liquid is collected in the tank 20 (post-wash tank 20) of the post-washing zone 9, from which it is conveyed via a pump system to the spray nozzles 14 (post-wash nozzles 14) of the post-washing zone 9. In the post-washing zone 9, washing liquid is rinsed from the washware. The liquid resulting from this flows into the wash tank 18b of the second main washing zone 8, is usually provided with a cleaning agent and then sprayed onto the washware by a pumping system via the nozzles 13 (wash nozzles 13) of the second main washing zone 8.

Liquid flows from the wash tank 18b of the second main washing zone 8 into the wash tank 18a of the first main washing zone 7. From there, the liquid is again sprayed onto the washware by a further pump system via the wash nozzles 12 of the first main washing zone 7. From the wash tank 18a of the first main washing zone 7, the liquid then flows into the pre-wash tank 16 of the pre-washing zone 6. Liquid in the pre-wash tank 16 is sprayed onto the washware by a pumping system via the pre-wash nozzles 11 of the pre-washing zone 6 in order to remove coarse impurities from the washware.

The individual rinsing systems of the treatment zones 6, 7, 8, 9, and 10 ensure that the washware is sprayed from both the top and the bottom.

The respective zones 6, 7, 8, 9, and 10 of the conveyor warewasher 1 can be separated from one another via separating curtains 37. In the embodiment shown in FIG. 1, the inlet tunnel 5 itself is also separated from the inlet 4 via a separating curtain 37. The provision of separating curtains 37 can prevent washing liquid and rinsing liquid from splashing out and steam from escaping from the conveyor warewasher.

The aforementioned drying zone 26 follows the rinsing zone 10 in the direction of conveyance 3 of the washware. In the drying zone 26, the washware is dried with dry and heated air in order to blow off or dry the moisture that is present on the washware. In order to maintain the moisture content of the air within a range that is favorable for drying, it is conceivable, for example, to supply room air via an opening, for example through the exit opening for the washware. The warm and moistened air is extracted from the drying zone 26, for example, by means of a fan 31 via a further opening.

It is advantageous for the exhaust air from the drying zone 26 to pass through a device for heat recovery 30, in which a condenser can be provided. The heat recovery device 30 serves to recover at least a portion of the heat energy contained in the exhaust air.

In today's belt/rack conveyor warewashers, the washware is conveyed through a plurality of treatment zones, such as pre-washing zones, main washing zones, post-washing zones, rinsing zones, and drying zones.

As already indicated, different types of washware in the treatment zones of the conveyor warewasher require different treatment parameters. However, with the currently known conveyor warewashers, there is no automatic differentiation of the types of washware to be treated, so that conventional systems are typically designed as a compromise, such that they are more or less efficient for multiple types of washware. This approach leads to the fact that significantly more resources (energy, water, chemicals, etc.) are generally used in order to treat the washware than would actually be necessary.

The conveyor warewasher 1 according to the invention, as shown for example in FIG. 1, is characterized in that the conveyor warewasher 1 comprises a camera system 34, which is arranged above the conveyor apparatus 2 and is designed to take at least one image of an area of the conveyor apparatus 2, preferably continuously or at predetermined or determinable times and/or events.

The camera system 34 is associated with an image processing device 35, which is designed to, in particular optionally, pre-process the at least one image captured by the camera system 34, segment the particularly optionally pre-processed image, extract features, and classify objects contained in the image (washware items).

In particular, the image processing device is designed to determine a position, orientation, and/or alignment of washware items contained in the at least one captured image.

The solution according to the invention furthermore employs an evaluation device, which is designed to evaluate the determined position, orientation, and/or alignment of the washware items and determine whether there are washware items in the area of the conveyor apparatus at the time of the image acquisition that:
i) are transported in an incorrect orientation by the conveyor apparatus; and/or
ii) are transported in an incorrectly aligned orientation by the conveyor apparatus.

It must be taken into account that each washware item has an optimum orientation when the washware item is transported through the treatment zones of the conveyor warewasher 1 by the conveyor apparatus 2. The same applies to the alignment of the washware items.

For example, cups and pots are typically oriented and aligned so as to be transported through the individual treatment zones of the transport washer 1 at least partly upside down by the conveyor apparatus 2. Herein it should be noted that the spray or air nozzles of the treatment zones of the conveyor warewasher 1 are typically designed to achieve an optimal treatment result when the washware items are transported in the desired optimal orientation or alignment by the conveyor apparatus 2.

Flat washware items, such as plates or trays, are preferably received by the conveyor apparatus 2 in a slightly inclined vertically upright position, since it is assumed that such washware items are often soiled only to a relatively low degree. On the other hand, the nearly vertically oriented positioning of the washware items allows the conveyor apparatus 2 to be loaded in the most compact manner possible, and is also helpful for draining the liquid that is sprayed onto the washware items after treatment.

The conveyor warewasher 1 according to the invention, which is schematically shown by way of an exemplary embodiment in FIG. 1, is particularly distinguished by the fact that the control device 36 that is associated with the conveyor warewasher 1 is designed to output a corresponding error or warning, in particular to the washing personnel assigned to the conveyor warewasher 1 and/or the operator of the conveyor warewasher 1, when the evaluation device determines that at the time of image acquisition, in the area of the conveyor apparatus 2:
at least one incorrectly oriented washware item is being transported by the conveyor apparatus 2; and/or
a pre-determined or fixed (minimum) number of incorrectly oriented washware items are being transported by the conveyor apparatus 2; and/or
at least one incorrectly aligned washware item is being transported by the conveyor apparatus 2; and/or
a pre-determined or fixed (minimum) number of incorrectly aligned washware items are being transported by the conveyor apparatus 2.

The error or warning message allows the washing personnel to correct the incorrect orientation or alignment of the respective washware item, if necessary, or to stop the conveyor apparatus 2 and/or at least temporarily reverse the transport direction of the conveyor apparatus 2 (in order to optionally move the conveyor apparatus some distance if necessary—e.g., for very large washware)) in order to perform a corresponding correction.

On the other hand, the error or warning can also serve to enable the washing personnel to optionally re-check and, if necessary, clean the incorrectly oriented or incorrectly aligned washware items after treatment in the treatment zones of the conveyor warewasher 1.

However, it is also conceivable in this context that the control device 36 of the conveyor warewasher 1 is designed to control the conveyor warewasher 1 and, in particular, the conveyor apparatus 2 of the conveyor warewasher 1 and, in particular, to stop the conveyor apparatus 2 of the conveyor warewasher 1 and/or at least temporarily reverse the transport direction of the conveyor apparatus 2 when the evaluation determines that, at the time of image acquisition, at least one incorrectly oriented washware item is being transported by the conveyor apparatus 2 in the area of the conveyor apparatus 2, and/or a predetermined or fixed (minimum) number of incorrectly oriented washware items are being transported by the conveyor apparatus 2, and/or at least one incorrectly aligned washware item is being transported by the conveyor apparatus 2, and/or a pre-determined or fixed (minimum) number of incorrectly aligned washware items are being transported by the conveyor apparatus 2.

Alternatively or in addition to this preferably automatic intervention, as far as the transport speed of the conveyor apparatus 2 is concerned, it is conceivable that the control device 36 activates and/or deactivates an additional washing system in the at least one washing zone and/or an additional rinsing system in the at least one rinsing zone of the conveyor warewasher 1; and/or an additional drying system in an optional drying zone of the conveyor warewasher 1 is activated or deactivated, and/or the control device varies a quantity of washing liquid sprayed per time unit in the at least one washing zone and/or a quantity of rinsing liquid sprayed per time unit in the at least one rinsing zone if it is determined by the evaluation device that at least one incorrectly oriented washware item is being transported by the conveyor apparatus 2 at the time of the image capture in the area of the conveyor apparatus 2, and/or a predefined or definable (minimum) number of incorrectly oriented washware items are being transported by the conveyor apparatus 2, and/or at least one incorrectly aligned washware item is being transported by the conveyor apparatus 2, and/or a predefined or definable (minimum) number of incorrectly aligned washware items are being transported by the conveyor apparatus 2.

In a figurative sense, however, it is of course also conceivable that corresponding measures are initiated in the at least one drying zone of the conveyor warewasher 1, such as, for example, increasing the drying air blown onto the washware per time unit, and/or increasing the temperature of the drying air, and/or connecting an additional drying system.

Within the scope of machine learning, the control device 36 is preferably designed to derive corresponding patterns or regularities relating to the trend or temporal development of the incorrectly oriented and/or incorrectly aligned items of washware that are detected by the evaluation device.

For example, it is conceivable that the control device 36 is designed, in particular during an observation phase over an observation period that preferably relates to a rinsing shift or rinsing day of the conveyor warewasher 1, to determine a temporal development of the incorrectly oriented and/or incorrectly aligned washware items that are detected by the evaluation device, and preferably derive a pattern or regularity on the basis of the determined temporal development.

Alternatively or in addition, it is conceivable that the control device 36 is designed, in particular during an observation phase over observation period that preferably relates to a rinsing shift or rinsing day of the conveyor warewasher 1, to generate statistics on the type and/or time point of the incorrectly oriented and/or incorrectly aligned washware items.

Depending on the determined development over time or on the generated statistics, a corresponding message can be generated and, in particular, issued to the operator of the conveyor warewasher 1, wherein the message preferably contains a recommendation for optimized operation of the conveyor warewasher 1, in particular with regard to cleaning efficiency.

The invention furthermore relates to a method of operating a conveyor warewasher 1, in particular a conveyor warewasher 1 such as the one schematically shown in FIG. 1.

In the method, at least one image of an area of a conveyor apparatus 2 of the conveyor warewasher 1 is preferably recorded from above, below, or from the side at an inlet area of the conveyor warewasher 1 and, in particular, within an inlet tunnel of the conveyor warewasher 1. The at least one image is optionally pre-processed, and the optionally pre-processed image is segmented using an image processing device to extract features from objects contained in the image and classify the objects.

Based on the classification performed, an evaluation device is used to determine whether at least one incorrectly oriented washware item is being transported by the conveyor apparatus 2 in the area of the conveyor apparatus 2 at the time at which the image is captured, or whether at least one incorrectly aligned washware item is being transported by the conveyor apparatus 2 in the area of the conveyor apparatus 2 at the time at which the image is captured.

A corresponding error or warning message can then be output, in particular to the personnel assigned to the conveyor warewasher 1 or the operator of the conveyor warewasher 1.

The invention is not limited to the embodiment of the conveyor warewasher 1 schematically shown in FIG. 1, but results from a summary of all features disclosed herein.

1. A conveyor warewasher for cleaning washware, wherein the conveyor warewasher comprises at least one washing zone and at least one rinsing zone as well as a conveyor apparatus for conveying the washware through the at least one washing zone and the at least one rinsing zone (10),
characterized in that
the conveyor warewasher has a camera system, which is arranged above or below or to the side of the conveyor apparatus and is adapted to capture at least one image of a portion of the conveyor apparatus, wherein an image processing device is associated with the camera system that is adapted to determine a location, position, and/or orientation of washware items present in the at least one captured image, wherein an evaluation device is further provided that is adapted to determine based on the determined location, position, and/or orientation of the washware items whether, at the time of the image capture, washware items are present in the portion of the conveyor apparatus that:
i) are transported incorrectly oriented by the conveyor apparatus; and/or
ii) are transported misaligned by the conveyor apparatus.

2. The conveyor warewasher according to claim 1,
wherein the evaluation device is adapted to determine, based on training data, whether washware item parts are present in the portion of the conveyor apparatus at the time of image capture that are transported incorrectly oriented by the conveyor apparatus; and/or that are transported misaligned by the conveyor apparatus.

3. The conveyor warewasher according to claim 1,
wherein the evaluation device is adapted to determine, based on a comparison of at least portions of the at least one captured image using training images captured during a learning phase, whether washware items are present in the portion of the conveyor apparatus at the time of image capture that are transported incorrectly oriented by the conveyor apparatus; and/or that are transported misaligned by the conveyor apparatus.

4. The conveyor warewasher according to claim 1,
wherein the conveyor warewasher comprises a control device adapted to output an error or warning message, to the washing personnel associated with the conveyor warewasher and/or to the operator of the conveyor warewasher, if it is determined by the evaluation device that at the time of the image capture in the portion of the conveyor apparatus:
at least one incorrectly oriented washware item is transported by the conveyor apparatus; and/or
a pre-determined or fixed (minimum) number of incorrectly oriented washware items are transported by the conveyor apparatus; and/or
at least one misaligned washware item is transported by the conveyor apparatus; and/or
a pre-determined or fixed (minimum) number of misaligned washware items are transported by the conveyor apparatus.

5. The conveyor warewasher according to claim 1,
wherein the conveyor warewasher comprises a control device adapted to stop the conveyor apparatus of the conveyor warewasher and/or to at least temporarily reverse the transport direction of the conveyor apparatus, when the evaluation device determines that, at the time of image capture, in the portion of the conveyor apparatus:
at least one incorrectly oriented washware item is transported by the conveyor apparatus; and/or
a pre-determined or fixed (minimum) number of incorrectly oriented washware items are transported by the conveyor apparatus; and/or
at least one misaligned washware item is transported by the conveyor apparatus; and/or
a pre-determined or fixed (minimum) number of misaligned washware items are transported by the conveyor apparatus.

6. The conveyor warewasher according to claim 1,
wherein the conveyor warewasher comprises a control device adapted to activate or deactivate an additional washing system in the at least one washing zone and/or an additional rinsing system in the at least one rinse zone and/or an additional drying system in an optional drying zone of the conveyor warewasher and/or to vary an amount of washing liquid sprayed per unit of time in the at least one wash zone and/or to vary an amount of rinsing liquid sprayed per unit time in the at least one rinse zone, and/or to vary an amount of drying air sprayed per unit time in the optional drying zone, when the evaluation device determines that, at the time of image capture, in the portion of the conveyor apparatus:
at least one incorrectly oriented washware item is transported by the conveyor apparatus; and/or
a pre-determined or fixed (minimum) number of incorrectly oriented washware items are transported by the conveyor apparatus; and/or
at least one misaligned washware item is transported by the conveyor apparatus; and/or
a pre-determined or fixed (minimum) number of misaligned washware items are transported by the conveyor apparatus.

7. The conveyor warewasher according to claim 1,
wherein the conveyor warewasher comprises a control device adapted to:
during an observation phase over an observation period, relates to a washing shift or a washing day of the conveyor warewasher, to determine a development over time of the incorrectly oriented and/or misaligned washware items determined by the evaluation device, and to infer a pattern or a regularity based on the determined development over time; and/or
during an observation phase over an observation period, which relates to a washing shift or a washing day of the conveyor warewasher, to generate statistics on the type and/or the timing of the incorrectly oriented and/or incorrectly aligned washware items.

8. The conveyor warewasher according to claim 7, wherein the control device is further adapted to output to the operator of the conveyor warewasher a corresponding notification depending on the determined development over time and/or as a function of the statistics created, wherein the notification contains a recommendation for operation of the conveyor warewasher optimized with regard to cleaning efficiency.

9. The conveyor warewasher according to claim 1,
wherein the image processing device is adapted to pre-process the at least one image captured by the camera system, to segment the in pre-processed image, and to extract features of, and to classify, objects contained in the image, wherein the image processing device is further adapted to extract a location, position, and/or orientation of the washware items in the portion of the conveyor apparatus as a feature of the washware items in the image, and wherein the image processing device is further adapted to classify the washware items based on the extracted location, position, and/or orientation of the washware items in the portion of the conveyor apparatus, namely into:
a) a first class comprising washware items whose orientation does not correspond to a predetermined or predeterminable orientation; and/or
b) a second class comprising washware items whose orientation corresponds to a predetermined or predeterminable orientation; and/or
c) a third class comprising washware items whose alignment does not correspond to a predetermined or predeterminable alignment; and/or
d) a fourth class comprising washware items whose alignment corresponds to a predetermined or predeterminable alignment.

10. The conveyor warewasher according to claim 9,
wherein the image processing device is further adapted to classify the washware items based on the extracted location, position, and/or orientation, of the washware items in the portion of the conveyor apparatus, namely into:
e) a fifth class comprising washware items whose position on the conveyor apparatus does not correspond to a pre-determined or predeterminable position; and/or
f) a sixth class comprising washware items whose position on the conveyor apparatus (2) corresponds to a pre-determined or predeterminable position.

11. The conveyor warewasher according to claim 1,
wherein the orientation of a washware item corresponds to the predetermined orientation when the washware item is transported upside-down by the conveyor apparatus; and/or
wherein the orientation of a washware item corresponds to the predetermined alignment when the washware item is aligned upside down with respect to the conveyor apparatus.

12. A method for operating, wherein the method comprises the following method steps:
in an inlet portion of the conveyor warewasher, at least one image of a portion of a conveyor apparatus of the conveyor warewasher is captured from above or below or from the side;
the at least one image is optionally pre-processed, and the optionally pre-processed image is segmented using an image processing device in order to extract features of objects contained in the image and to classify the objects; and
based on the classification performed, an evaluation device is used to determine whether at the time of image capture in the portion of the conveyor apparatus at least one incorrectly oriented washware item is transported by the conveyor apparatus and/or whether at the time of image acquisition in the portion of the conveyor apparatus at least one incorrectly aligned washware item is transported by the conveyor apparatus.

13. The method according to claim 12,
wherein an error or warning message is output to the washing personnel associated with the conveyor warewasher and/or to the operator associated with the conveyor warewasher when it is determined by the evaluation device that at the time of the image capture in the portion of the conveyor apparatus:
at least one incorrectly oriented washware item is transported by the conveyor apparatus; and/or
a pre-determined or fixed (minimum) number of incorrectly oriented washware items are transported by the conveyor apparatus; and/or
at least one misaligned washware item is transported by the conveyor apparatus; and/or
a pre-determined or fixed (minimum) number of misaligned washware items are transported by the conveyor apparatus.

14. The method according to claim 12,
wherein the method further comprises the following method steps:
during an observation phase, which relates to a washing shift or a washing day of the conveyor warewasher, a development over time of the incorrectly oriented and/or misaligned washware items determined by the evaluation device is determined over an observation period, and a pattern or a regularity is preferably inferred based on the determined development over time; and/or
during an observation phase over an observation period, which relates to a washing shift or a washing day of the conveyor warewasher, statistics are generated about the type and/or the time of the incorrectly oriented and/or misaligned washware items transported with the conveyor apparatus.

15. The method according to claim 14,
wherein a corresponding notification is generated and/or output to the operator of the conveyor warewasher depending on the determined development over time and/or the statistics created, wherein the notification contains a recommendation for optimized operation of the conveyor warewasher with regard to cleaning efficiency.
